(19) United States
(12) Patent Application Publication
(10) Pub. No.: US 2020/0128835 A1
(43) Pub. Date: Apr. 30, 2020

(54) COMPOSITION AND METHOD OF PREPARING GOURMET WAFFLES

(71) Applicant: Bennett McKiver, SR., Killeen, TX (US)

(72) Inventor: Bennett McKiver, SR., Killeen, TX (US)

(21) Appl. No.: 16/172,238

(22) Filed: Oct. 26, 2018

(51) Int. Cl. A21D 13/40; A21D 10/00; A21D 6/00; A21D 2/34; A21D 2/14

(52) U.S. Cl. CPC A21D 13/40; A21D 10/005; A21B 5/02; A21D 2/34; A21D 2/145; A21D 6/003

(57) ABSTRACT

The present invention discloses a method for preparing gourmet waffles. The composition or ingredients of the gourmet waffles includes at least four cups of pancake mixture, ⅔ to 3 cups of water, at least three eggs, ½ cup of oil and at least one box of the cake mixture. The gourmet waffles could be prepared into any desired configurations includes a disk, a roll, and a square. The composition could be mixed in a bowl to make a dough or batter. The dough could be stirred and smooth via a whisk or a dough mixer. The dough is placed inside of a waffle maker or waffle iron and heated at a temperature of about 280 F. The gourmet waffles are toasted for predetermined time of about 3 to 5 minutes and then removed from the waffle iron. The method provides tastier and healthier gourmet waffles.

### BACKGROUND OF THE INVENTION

### A. Technical Field

The present invention generally relates to a composition and method for preparing food products. More specifically, the present invention relates to a composition and method for making gourmet waffles.

### B. Description of Related Art

Frozen toaster products, such as a toaster waffles, have become widely consumed as part of a meal due to their convenience and short preparation time. Waffle is a dish made from leavened batter or dough that is cooked between two plates that are patterned to give a characteristic size, shape, and surface impression. There are many variations based on the type of waffle iron and recipe used. Waffles are eaten throughout the world, which has over a dozen regional varieties. Waffles may be made fresh and simply heated after having been commercially precooked and frozen.

Currently, commercial waffles are varying or changing the quality with respect to the taste. The waffles have tedious taste, so the people couldn't like the taste of the waffles. In addition, for preparing the waffles, unsanitary substandard raw materials are used, this could pose a threat to people's health. Due to the lack of new ideas for preparing the waffles, it could not meet the consumer demands.

Therefore, there is a need for a method to improve the quality and prepare the waffles with different tastes. There is also a need for a method to improve the taste of the waffles with new ideas for preparing the gourmet waffles to satisfy the consumers.

### SUMMARY OF THE INVENTION

The present invention discloses a method for preparing food products. More specifically, the present invention relates to a method for preparing gourmet waffles.

In one embodiment, the gourmet waffle is a dish made from leavened batter or dough that is cooked between two plates that are patterned to give a characteristic size, shape, and surface impression. In one embodiment, the gourmet waffles could be prepared into any desired configuration, but not limited to, a disk, a roll, and a square. In one embodiment, the gourmet waffles could be heated via, but not limited to, an oven and a toaster.

In one embodiment, the gourmet waffles are prepared from the composition including a pancake mixture, water, eggs, oil, and a cake mixture. In one embodiment, the pancake mixture could be at least four cups, ⅔ to 3 cups of water, at least three eggs, ½ cup of oil and at least one box of cake mixture. The composition or ingredients could be mixed in a bowl to make a dough or batter. In one embodiment, the batter could be stirred and smoothed via a cooking utensil, but not limited to, a whisk or a dough mixer.

In one embodiment, the dough or batter could be placed inside of, but not limited to, a waffle maker and a waffle iron. In one embodiment, a sufficient amount of dough or baker could be placed between the two plates of the waffle maker or waffle iron, which are then closed to bake or heat the dough for preparing the gourmet waffles. In one embodiment, the waffle maker has hexagonal recesses to shape the dough into hexagonal-shaped gourmet waffles. In some embodiments, the waffle maker has circular recesses to shape the dough into circular-shaped gourmet waffles.

In one embodiment, the method for preparing gourmet waffles includes multiple steps. At step one, a user could take at least four cups of pancake mixture in a bowl. In some embodiments, the user could take the four cups of pancake mixture in, but not limited to, a dish, a pan, and a vessel. At another step, the user could add ⅔ to 3 cups of water and at least three eggs to the mixture. At another step, the user could add at least ½ cup of oil and at least one box of cake mixture to the mixture of the previous step. At another step, the user could stir the mixture of the previous step until it is smooth. The user could smooth the mixture via, but not limited to, a whisk or a dough mixer. Further, the user could heat the mixture at a temperature of about 280 F for a predetermined time such that the gourmet waffles become fully toasted. The gourmet waffles are toasted or baked for the predetermined time of about 3 to 5 minutes and then removed from the waffle iron or the waffle maker. The present method provides tastier and healthier gourmet waffles. The people could take the delicacies gourmet waffles with a sweet dessert flavor for a breakfast or a meal due to their convenience and short preparation time, very similar to pancakes but lighter and sweeter.

Other objects, features and advantages of the present invention will become apparent from the following detailed description. It should be understood, however, that the detailed description and the specific examples, while indicating specific embodiments of the invention, are given by way of illustration only, since various changes and modifications within the spirit and scope of the invention will become apparent to those skilled in the art from this detailed description.

### BRIEF DESCRIPTION OF DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and structures disclosed herein. The description of a method step or a structure referenced by a numeral in a drawing is applicable to the description of that method step or structure shown by that same numeral in any subsequent drawing herein.

FIG. 1 exemplarily illustrates a flowchart of a method for preparing gourmet waffles, according to one embodiment of the present invention.

### DETAILED DESCRIPTION OF EMBODIMENTS

A description of embodiments of the present invention will now be given with reference to the Figures. It is expected that the present invention may be embodied in other specific forms without departing from its spirit or essential characteristics. The described embodiments are to be considered in all respects only as illustrative and not restrictive.

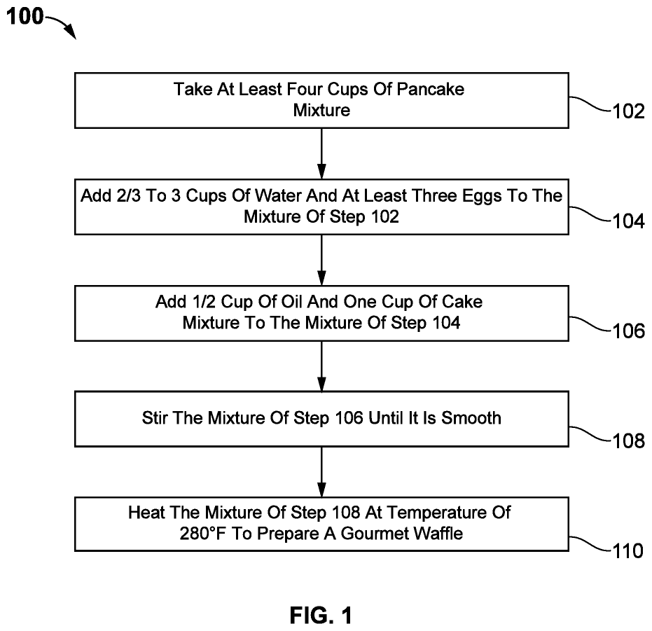

Referring to FIG. 1, a flow chart 100 of a method for preparing gourmet waffles is illustrated. In one embodiment, the gourmet waffle is a dish made from leavened batter or dough that is cooked between two plates that are patterned to give a characteristic size, shape, and surface impression. In one embodiment, the gourmet waffles could be prepared into any desired configuration, but not limited to, a disk and a square. In one embodiment, the gourmet waffles could be heated via, but not limited to, an oven and a toaster.

In one embodiment, the gourmet waffles are prepared from the composition including a pancake mixture, water, eggs, oil, and a cake mixture. In one embodiment, the pancake mixture could be at least four cups, ⅔ to 3 cups of water, at least three eggs, ½ cup of oil and at least one box of cake mixture. These all ingredients could be mixed in a bowl to make a dough or batter. In one embodiment, the batter could be stirred and smoothed via a cooking utensil, but not limited to, a whisk or a dough mixer.

In one embodiment, the dough or batter is placed into, but not limited to, a waffle maker and a waffle iron. In one embodiment, sufficient amount of dough could be placed between the plates of the waffle maker or waffle iron, which are then closed to bake or heat the dough for preparing the gourmet waffles. In one embodiment, the waffle maker has hexagonal recesses to shape the dough into the hexagonal-shaped gourmet waffle. In some embodiments, the waffle maker has circular recesses to shape the dough into the circular-shaped gourmet waffle.

In one embodiment, the method for preparing gourmet waffles includes multiple steps. At step 102, a user could take at least four cups of pancake mixture in a bowl. In some embodiments, the user could take the four cups of pancake mixture in, but not limited to, a dish, a pan, and a vessel. At step 104, the user could add ⅔ to 3 cups of water and at least three eggs to the mixture of step 102. At step 106, the user could add at least ½ cup of oil and at least one box of cake mixture to the mixture of step 104. At step 108, the user could stir the mixture of step 106 until it is smooth. The user could smooth the mixture of step 106 via, but not limited to, the whisk or dough mixer. At step 110, the user could heat the mixture of step 108 at a temperature of about 280 F for a predetermined time such that the gourmet waffles become fully toasted. The gourmet waffle is toasted or baked for the predetermined time of about 3 to 5 minutes, and then removed from the waffle iron or the waffle maker. The present method provides tastier and healthier gourmet waffles. The people could take the delicacies gourmet waffles for breakfast with a sweet dessert flavor, very similar to pancakes but lighter and sweeter.

Preferred embodiments of this invention are described herein, including the best mode known to the inventors for carrying out the invention. It should be understood that the illustrated embodiments are exemplary only, and should not be taken as limiting the scope of the invention.

The foregoing description comprise illustrative embodiments of the present invention. Having thus described exemplary embodiments of the present invention, it should be noted by those skilled in the art that the within disclosures are exemplary only, and that various other alternatives, adaptations, and modifications may be made within the scope of the present invention. Merely listing or numbering the steps of a method in a certain order does not constitute any limitation on the order of the steps of that method. Many modifications and other embodiments of the invention will come to mind to one skilled in the art to which this invention pertains having the benefit of the teachings presented in the foregoing descriptions. Although specific terms may be employed herein, they are used only in generic and descriptive sense and not for purposes of limitation. Accordingly, the present invention is not limited to the specific embodiments illustrated herein.

What is claimed is:

1. A composition of the gourmet waffles, comprising:
a pancake mixture, water, eggs, oil, and a cake mixture.

2. The composition of claim 1, wherein the pancake mixture is at least four cups.

3. The composition of claim 1, wherein the required amount of water is ⅔ to 3 cups.

4. The composition of claim 1, wherein at least three eggs are required to prepare the pancake mixture.

5. The composition of claim 1, wherein the required amount of oil is ½ cup.

6. The composition of claim 1, wherein the required amount of cake mixture is at least one box.

7. A method for preparing gourmet waffles, comprising:
taking a pancake mixture;
adding water and eggs to the pancake mixture;
adding oil and cake mixture to the pancake mixture;
stirring the pancake mixture until it is smooth; and
heating the pancake mixture at a temperature for a predetermined time such that the gourmet waffles is toasted.

8. The method of claim 7, wherein the pancake mixture is at least four cups.

9. The method of claim 7, wherein the required amount of water is ⅔ to 3 cups.

10. The method of claim 7, wherein at least three eggs are required to prepare the pancake mixture.

11. The method of claim 7, wherein the required amount of oil is ½ cup.

12. The method of claim 7, wherein the pancake mixture is heated at a temperature of about 280 F.

13. The method of claim 7, wherein the predetermined time for toasting or baking the gourmet waffles is between 3 to 5 minutes.
